(19) United States
(12) Patent Application Publication
(10) Pub. No.: US 2016/0042449 A1
(43) Pub. Date: Feb. 11, 2016

(54) MICRO LENDING METHOD AND APPARATUS

(71) Applicant: CACHET FINANCIAL SOLUTIONS INC., Minneapolis, MN (US)

(72) Inventor: Christopher EBBERT, Minneapolis, MN (US)

(73) Assignee: CACHET FINANCIAL SOLUTIONS INC., Minneapolis, MN (US)

(21) Appl. No.: 14/173,375

(22) Filed: Feb. 5, 2014

Related U.S. Application Data
(60) Provisional application No. 61/760,736, filed on Feb. 5, 2013.

(51) Int. Cl. G06Q 40/02; G06K 9/00

(52) U.S. Cl. CPC G06Q 40/025; G06K 9/00442

(57) ABSTRACT

A remote deposit capture system, comprising, a server adapted for centralized receipt of remote capture deposit transactions, a financial institution system adapted for receipt of remote capture deposit transactions information from said server and for crediting accounts based thereon, an internet transaction application adapted for communication with said server and for digital acquisition and processing of checks, loan applications, loan repayment, and a digital acquisition device adapted for communication with said application and for capturing of checks.

### RELATED APPLICATIONS

The present application claims priority to, and incorporates by reference thereto, U.S. Provisional Patent Application No. 61/760,736 filed on Feb. 5, 2013.

### BACKGROUND

1. Field of the Invention

This invention relates to a method and apparatus for processing loans and loan applications utilizing remote deposit capture. In particular, the invention relates to a method and apparatus for remote deposit capture of a financial instrument and applying the funds to one or more streams of payment or deposit, and to enter into financial transactions such as loans, loan applications, and loan repayment. Of course, a person of ordinary skill in the art will understand that the invention is not necessarily so limited.

2. Background of the Invention

Remote Deposit Capture (“RDC”) had been termed one of the most important developments the banking industry has seen in years. The Federal Reserve, nearly all of the top banks in the US, as well as other important financial institutions have either endorsed or launched RDC services.

Heretofore, it has not been possible to enter into financial transactions such as loans, loan applications, or loan repayments without in person interaction that includes such things as extensive application and documentation processing. These requirements greatly reduced the opportunity for entering into such transactions, since the timing was limited by banking hours and customer availability within such hours. RDC, however, provides a way to substantially eliminate such limitations.

In general, terms, RDC is a service that allows a user to scan or digitally reproduce checks or other financial instruments and transmit the images to a bank for posting and clearing. The basic requirements for RDC services currently include a user computing device, an Internet or network connection, a scanner/digital camera, and a RDC service provider such as a bank or a third party provider working with the bank. Financial instruments, such as checks, are digitized to create a digital image. This digital image is then transmitted (usually over an encrypted internet connection) to a RDC processor and is then eventually cleared for deposit.

The advantages of RDC are many. For businesses, the advantages include accelerated clearings, improved availability of banking services, enhanced cash flow, reduced costs, and consolidation of banking relationships. Similarly, RDC is beneficial to financial institutions by providing them with reduced transportation costs, new revenue streams and customers, and reduced processing and clearing costs. Consumers/users also benefit because they do not have to physically travel to a financial institution, and can conduct business with any institution and not just those located in nearby.

RDC does suffer from significant drawbacks. In particular, prior art systems do not recognize or allow for accounting to different streams of payment of deposit. In general, the funds processed by RDC either are deposited into an account with a financial institution, or are credited to a debit card (or the like). There is not ability for the consumer or the financial institution to divide the financial instruments processed by RDC between different payment or accounting streams, or to enter into financial transactions such as loans, loan repayment, and the like. The consumer might have multiple accounts or be engaged in multiple transactions with the financial institution and would like the financial instrument treated in multiple manners in accord thereto.

Accordingly, a need exists for a RDC system that overcomes the difficulties of the prior art by providing a system the can more easily divide a financial instrument between accounting streams.

### BRIEF DESCRIPTION FO THE FIGURES

FIG. 1 shows an ITA workflow.

FIG. 2 show process workflow.

FIG. 3 shows a cancel feature of the ITA

FIG. 4 shows a connection flow between system components.

FIG. 5 shows a personal information page.

FIG. 6 shows an input workflow.

FIG. 7 shows an income verification page.

FIG. 8 shows a system flowchart.

### DETAILED DESCRIPTION OF THE PREFERRED EMBODIMENTS

The present invention relates to a method and apparatus for applying for, negotiating, and servicing loans through the use of remote deposit capture as described herein. The apparatus and methodology described hereinbelow can be adapted to applying for, processing loans, and loan repayment. In the course of such activities remote deposit capture technology is used to capture instruments, and in particular paper instruments associated with such transactions. These instruments can take the form of any type of document associated therewith such as drivers license, passport, checks, W2, pay stubs, social security cards, bank statements, tax documents, credit card statements, credit score documentation, contracts, leases, liens, title information, and the like. Reference to checks used to explain the operation of the present invention are exemplary and not meant to limit the applicability of the invention. Any instrument associated with a transaction can be processed in accord with the methods and methodology described herein.

In particular, if a user wanted to apply for, and receive, a loan from a financial institution the foregoing could be adapted for such activity. The process would begin with the user entering account information to initiate a session and then selecting a loan application function where the user would provide information regarding the request for a loan. This would include identifying the amount of the loan, possible payment terms, and any other information that would be associated with such a request.

Next, a verification step would be performed. The user would provide one or more required documents through the apparatus described below, such as identification (like a driver's license), bank statement, pay stub, and the like. These documents would be transmitted in the same manner as a check as described hereinbelow. The user would establish a connection, and enter in account information, as well as transmitting the foregoing documentation. The documentation would be processed, for example using character recognition technology, and analyzed for verification purposes. A second verification step can be performed by human review of the documentation as well as any other pertinent information such as account status, past payment and credit history, and the like.

If one, or both, of the verification steps fail, the user would be notified and could be given an option to supply additional information, correct any missing information, or to follow up with the financial institution in person or by phone to try and address any remaining obstacles or concerns.

A further option resulting from the verification process includes a modification of the loan request. For example, while the user might not be approved or qualify for the initial loan request, the request could be modified to meet the limitations imposed there on. In this case, the user could be notified that they have been approved for a loan of a lower amount than requested, or on different payment terms or interest rates than initially requested or provided. The user would have the option of accepting or declining the modified terms.

If the user agrees to the modification, or if the user is approved without modification, the process is finalized and the funds released in one or more manners. The funds can be made available, at the user's or the financial institution's option, by depositing them in a bank account such as a checking account, placing the funds onto a debit card or loan card that the user can then use at their convenience, or the user can receive cash which they can pick up at an applicable location such as a financial institution office.

Loan repayment can also be processed using the apparatus and methods described hereinbelow. The user would process a check, such as a paycheck, in the manner described below. At some point before the funds are made available to the user, a check would be performed to see if the user has any outstanding loan balances. If the user does have a loan balance, the user would be prompted to apply some or the entire check amount to the outstanding loan balance. The user could input the amount to apply, or decline to apply any of the check to the loan balance.

The financial institution can then evaluate and verify the transaction. If the user has a loan balance and declines to apply the check to the balance (or declines to apply a significant enough portion to the loan balance), the transaction may be declined, or the terms of the transaction altered. For example, the financial institution may require a different fee for the transaction or different payment terms. If the terms are accepted, or if the transaction is otherwise approved, the transaction would be processed as set forth above.

Additional information that can be made available in an automated manner to the financial institution to assist in evaluating loan approval includes check deposit history, bill payment history, and other indicia of credit worthiness. This information can be provided by, or from, the server processing the RDC transaction.

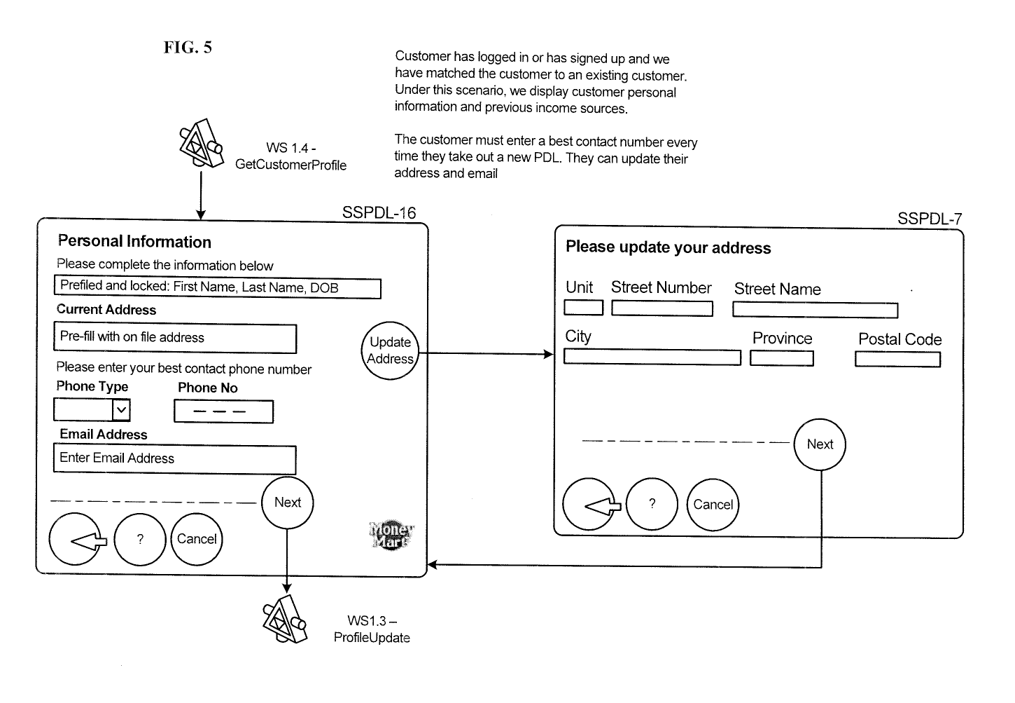

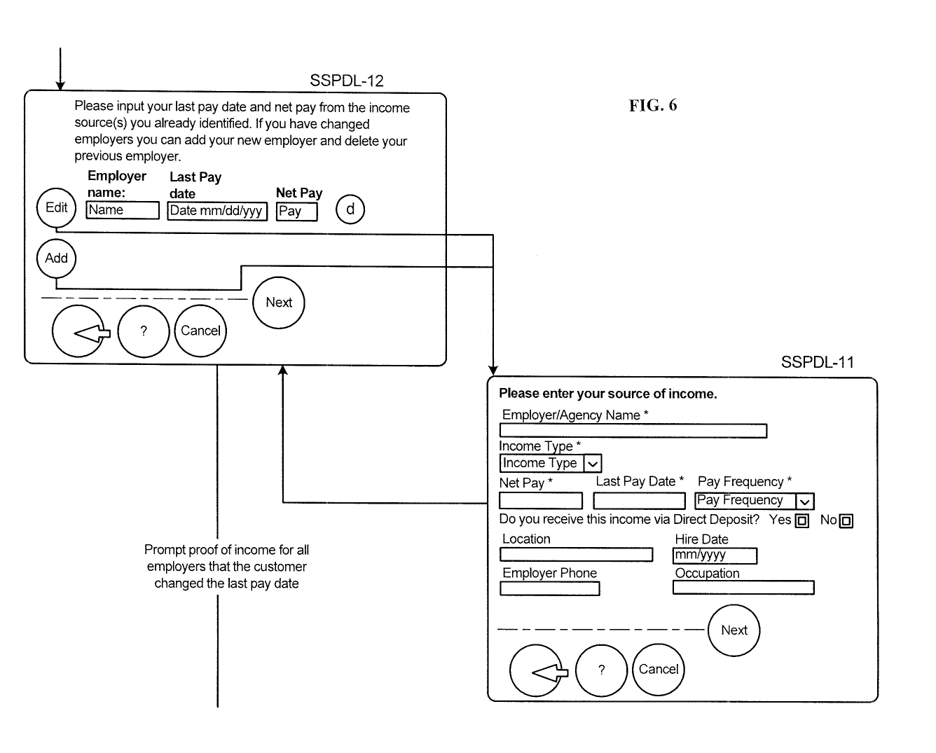

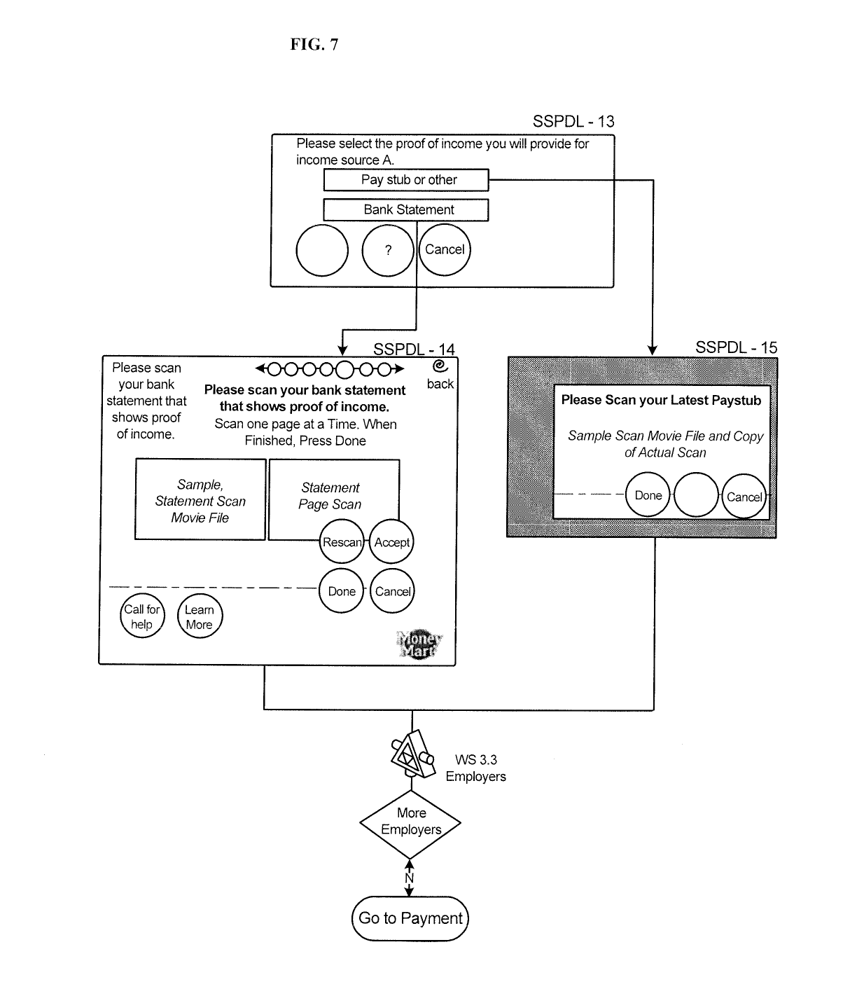

An example of a lending workflow is provided in FIGS. 5-7. FIG. 5 shows a personal information page, which allows for input and updating of user personal information. FIG. 6 shows a portion of the workflow that asks the user to input payday, employment information, and income source information. FIG. 7 shows a portion of the workflow that inputs income verification information. The functionality of the entire workflow would be implemented in a similar manner.

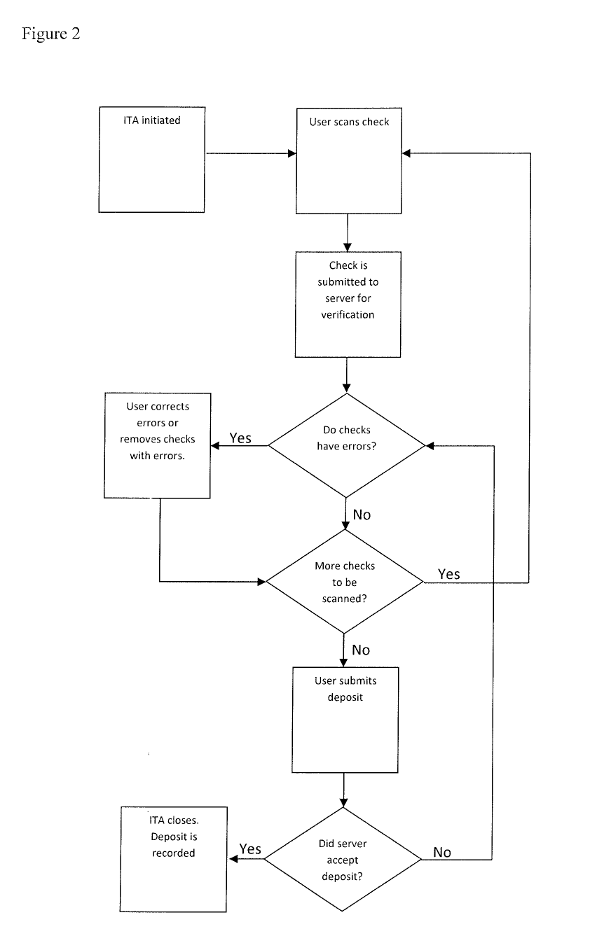

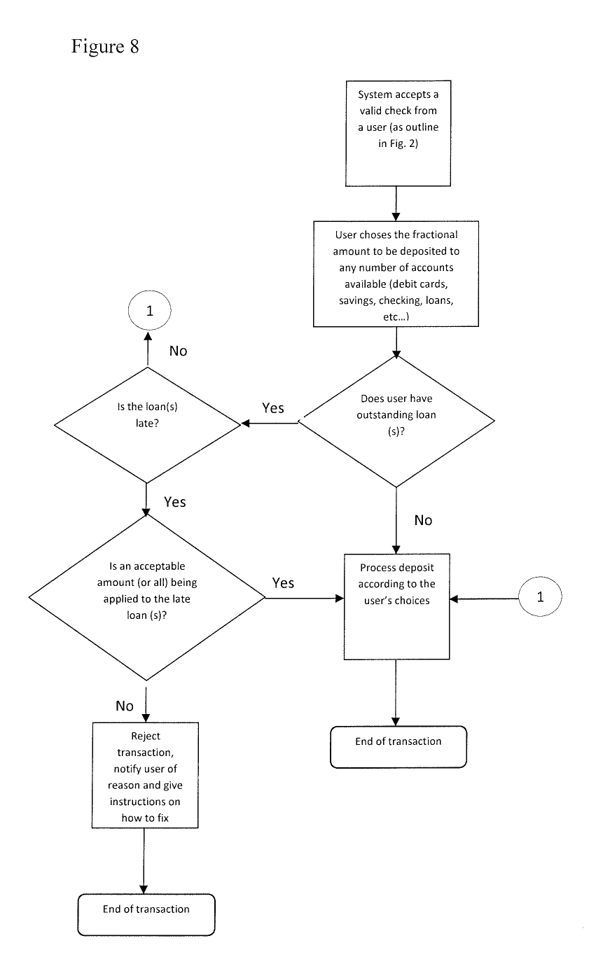

FIG. 8 shows the steps associated with payment processing. The process begins with a user submitting a financial instrument representing a payment from the user to one or more sources. In one embodiment, the payment could be a check processed by the system in accord with the method provided in reference to FIG. 2. The check could be a personal check, a paycheck, or from a third party. User would then select from any number of payment streams how the check is to be divided therebetween. The payment streams include, checking account, credit/debit cards, savings account, bill payment, or loan payment, and the like.

The system would then use the available information to determine if the user has a loan, or other payment obligation, outstanding. If not, the transaction would proceed as prescribed by the user. If the user does have such an obligation, the system would verify whether the user had met the current repayment obligations, such as whether or not the user was delinquent or late on the payment. If not, the transaction would proceed as prescribed by the user. If yes, the system would verify whether the user has allocated a sufficient portion of the payment to the delinquent obligation. If yes, the transaction would proceed as prescribed by the user. If no, the system would then initiate some sort of corrective action.

The corrective action could be in the form of a rejection, notifying the user that the transaction will not be completed and provide the user with an explanation, which the user could then use to correct the problem and resubmit the transaction accordingly. Other actions could be taken as well, such as realigning the transaction to meet the minimum requirements and asking the user to approve, creating a notice of alert to allow financial institution personnel to intervene, suspending account activity, assessing penalties or fees, and the like.

The invention makes use of an internet transaction application (“ITA”) that a user utilizes through a web interface and is comprised of code embedded in web pages accessed via a conventional web browser, wherein the web interface is provide remotely by a server.

The user triggers the launch of the ITA by responding to a prompt such as “Make New Deposit” on the web interface. The ITA is then delivered and executed through embedded coded in web pages provided from the server locally to the user's computer. Alternatively, the ITA (or some portion thereof) may already reside on the local computer as a result of a prior use, and in which case the embedded application may launch locally. The user's computer can comprises any number of devices, including, a mobile device using a mobile application designed for carrying out the present invention. Such devices include a smart phone, a tablet computer, or handheld mobile devices with a network/internet connection capability.

During execution the ITA receives certain information, including configuration settings which can be comprised of one or more of the following: digital capture device type to be used (i.e. scanner or digital camera); any prior deposit information to be used or completed (if any); configuration of the deposit amount (either auto balance or user balance—described in detail below); settings to control whether duplicate checks are allowed, and settings for determining if user can edit certain fields (such as ABA routing number, account number, check number, check amount, or how to handle the situation if the check fields cannot be fully read); and various other configuration parameters (like adding or setting logos, colors, fonts, and the like).

After configuration, the ITA assesses the state of the digital capture device, for example, a scanner. If the scanner cannot be found, an error is presented and the user is not allowed to scan any new checks, but the user can still edit a deposit (if one was sent down for edit by the server). The scanner can be declared a “load from local file” status, which would then allow the ITA to proceed without a physical scanner and instead process image files from other sources such as files stored on a hard drive.

After the state of the digital capture device is determined, the user has the ability to: scan new checks; remove checks that have already been scanned (either from a recent scan or from an edited deposit); close the deposit and terminate the session, or other capabilities as described herein below.

Next, the user is ready to start to scan checks by selecting a “Scan” prompt displayed by the ITA. Based on the type of scanner/device connected, the following will occur: Twain-compliant scanner—the user will be prompted to scan the front and then the back of the check, then once that is completed, the user will be able to scan a subsequent check; single-feed check scanner—the scanner will scan one check, and once that is completed, the user will be able to scan a subsequent check; multi-feed check scanner—the scanner will scan all of the checks in the batch, and once that is completed, the user will be able to scan a subsequent batch; or if no scanner is attached—the user will be prompted to find the local file of the front and then the back of the check, and upon completion the user will be able to prompted to load a subsequent check.

After every scanned check has been entered, the information about the check (image, MICR (if available from a dedicated check scanner)) is sent to the server. After the server performs recognition operations and is finished processing the check, the server passes down the information obtained thereby, including, the ABA, account number, check number, MICR (if not previously obtained), and amount on the check.

If server cannot identify any of the required fields then the user is allowed to update the values manually through the “Update” button (provided the user has been authorized), or processing will remain incomplete and the ITA will stop the closing of the deposit until the check is removed (provided the user does not or cannot make the foregoing corrections).

The ITA also provides the ability for the user, provided they have been given authorization, to remove checks that have been scanned (either from a recent scan or an edited deposit). A user can remove a check from the list of checks that have been previously scanned by clicking on the red ‘X’ next to the list of checks.

The ITA further provides the ability to close the deposit. Once the user is finished with scanning checks and editing the deposit, the deposit can be closed by selecting the “Complete” button. The deposit will be considered complete if the user balance entered sum of the checks matches the value entered (if applicable). If the value is not the same, the user may have the ability to update the user balance to match (ability depends on authorizations granted by the system administrator through admin settings configuration).

A check is also considered incomplete if it is missing the ABA, account number, check number, or amount. If the deposit is not considered complete, then the user must edit the deposit or the items until all error conditions are resolved (if granted authority) in order to complete the deposit.

More specifically, the present invention is described in references to the following figures and description. In the Figures, the functionality and description of the ITA is shown and described. The ITA includes areas reserved for a banner display, which can be customized for the user to include a corporate identified or other identifier. An area is reserved for a logo as well. A list of checks to be deposited is provided, and includes the check numbers, check amounts, and the status of the check (error status).

Each of the individual checks can be selected, which will a picture of the scanned or photographed check. Optionally, a feature next to the listing of the checks can be selected to toggle between displaying the front, back, or both sides of the check in a viewing area. Furthermore, the checks can be deleted (provided the user has been given edit authority) by selecting a delete feature adjacent to the listing of the checks.

The MICR data will appear since the application can read this information from the scanned/photographed image utilizing character recognition capability, or the information can be provided by the scanner. The check information is interpreted by character recognition software that can extract from the check the information written on the check. Typically, the recognition software runs on the server rather than the ITA, however, the invention is not so limited. Also, appearing adjacent to the image (provided the field can be interpreted) is the amount of the check in an editable field (in order to correct any errors in recognition—via the update feature that is described below).

A field is included to enter custom notes. The notes are typically entered by the user of the ITA for internal purposes as needed to associate information with processed checks. The notes are not sent with the image to the financial institution, but are kept in the system for storage and can reviewed through searches. There can be any reasonable number of note fields (not just one as is shown in the Figures).

A total showing the number of deposit items as well as a total for all the items is provided. The ITA also shows the scan feature, update feature, and the complete feature that submits the items appearing on the screen for deposit. The scan feature is used to actually initiate the image scan of the check(s).

The update feature is used to correct the data appearing above the notes field, such as the MICR data, the check amount, and the like. In the event that the software fails to properly interpret the check, the user can correct the data using the update feature. The ITA provides configurable settings to allow control over which users have access to the update function, and how much access they have (i.e. which data field they can correct).

The ITA can also be configured to display the user's location. Typically, the user will be a merchant, or some type of entity that receives checks from customers. The user can enter its location, and in the case of users with multiple locations, the ITA will allow the user to select between multiple locations. The ITA stores the location information as part of the operation of the software, and the location is used to create an ID associated with the check.

The ITA is configurable between an auto balance and user balance mode. In the auto balance mode, the checks are processed without a predetermined balance and there is no verification that the checks meet any requirements in terms of total amount. In the user balance mode, the user can enter in a total balance for one or more checks. Then the checks are scanned and processed. The ITA will issue an error if the total of the checks as determined by the ITA does not match the user balance. This serves as a way to detect any problems in the ability of the ITA to recognize the check amounts and can alert the user to possible missing checks or checks that were not scanned because they stuck together in a multi-document type scanner.

Further error detection is included in the ITA as well. For example, the ITA will search for duplicate checks to prevent the same check from being scanned and deposited more than once. Also, the ITA creates a watermark that it places on the image that indicates that the check has been processed (similar in purpose to the stamp placed on a check manually by a bank teller).

Additional screens include a login screen that appears before the ITA is launch that requests that the user enter a user name, and/or a password. A successful login launches the ITA. After the ITA launches, the user can then select a location (as described above). Next, the ITA will display a list of pending and submitted deposits associated with the user's location. The user can then submit any of the pending deposits, cancel (provided they have been given authority by the ITA configuration settings controlled by a systems administer), or add new transactions. Adding new transactions will take the user to the operational screen described above.

All transactions are given a unique identifier by the ITA, which consists of a combination of the user's location id and a data/time stamp. In this manner, each deposit transaction can be uniquely identified.

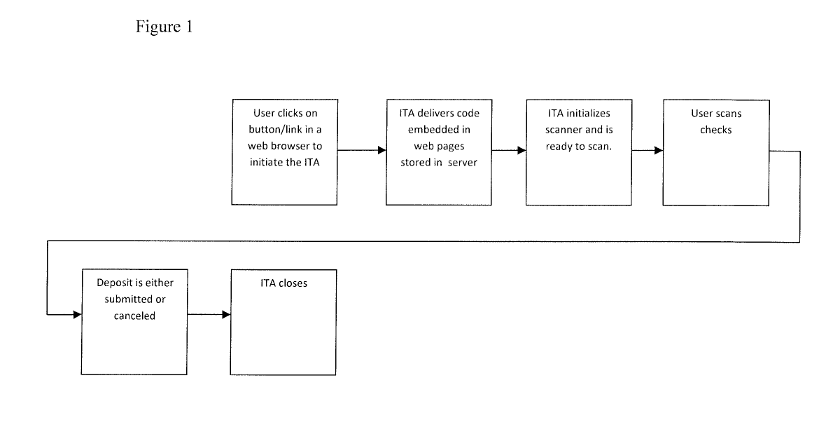

The flowchart in FIG. 1 discloses the workflow of the ITA. The first step involves having the user initiate the ITA preferably from a web browser or similar application. The ITA can be run on a desktop computer, a handheld computing device, from a smart phone, tablet computer, or the like. The ITA includes interfaces to communicate with a variety of computing devices and operating systems, such as Android devices, iOS devices, Blackberry devices, and Windows 8 mobile devices. The ITA can deliver to the devices through code embedded in the web pages the interfaces to necessary to communicate with the foregoing hardware, as well as the scanning or digitizing devices attached or affixed thereto.

After the ITA is initiated, the ITA delivers code necessary to perform the functionality described above through code embedded in web pages stored in a server which will process information from the computer running the ITA and interface with the computer of one or more financial institutions which hold the accounts which will receive the deposits.

The ITA then initializes the scanner, or alternatively a digital photographic device, or load images from the local computer that have been pre-scanned and stored. In one embodiment, a dedicated scanner can be attached to a desktop computer, but the invention is not necessarily limited. The ITA can communicate on a handheld device such as a smart phone or tablet computer with a built in scanner/camera.

Next, the user scans or photographs one or more check for which processing is desired. The ITA then processes the image either successfully, or with an error, and the user has the option to either submit the check for deposit, cancel the transaction, or if the ITA detects a problem, the user can try again to scan/photograph the check.

Finally, once all the checks have been processed the ITA session is terminated and the application closes.

The flowchart in FIG. 2 outlines more specifically the process of scanning/photographing checks and making deposits. This entire process preferably happens within the operation of the ITA. Initially, the ITA is initiated as described above. The user then scans/photographs one or more checks. The images of the checks is submitted to the sever processing the checks on behalf of the financial institution for verification.

A determination in made as to whether the image can be properly processed. Some common types of the errors that the server may detect include (but are not limited to): Cannot read MICR codes, cannot read check amount, check is a duplicate, check amount is too large, total deposit amount is too large, or deposit is empty. If an error is detected, the user is given a chance to correct any errors that are within the ability of the user to correct, and the check is reprocessed.

After the checks are scanned/photographed, the user submits the check for processing and deposit into one or more accounts at the applicable financial institution(s). The server processing the transactions on behalf of or through the financial institution returns an accepted or rejected message, prompting the ITA to either terminate the application if the transaction has been completed, or returning control to the errors decision step in case the transaction is not accepted by the server.

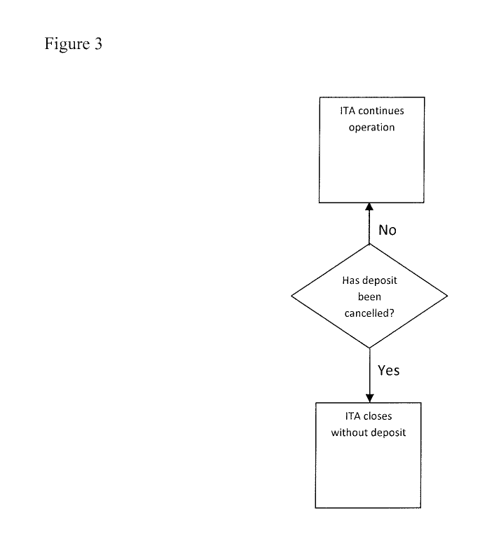

FIG. 3 outlines the cancel feature of the ITA. At any time during the operation of the ITA as described above, the user can cancel the operation and close the ITA. If the user does not cancel, then the ITA continues to operate. Cancelling can be done by closing the application or selecting the cancel button or the like.

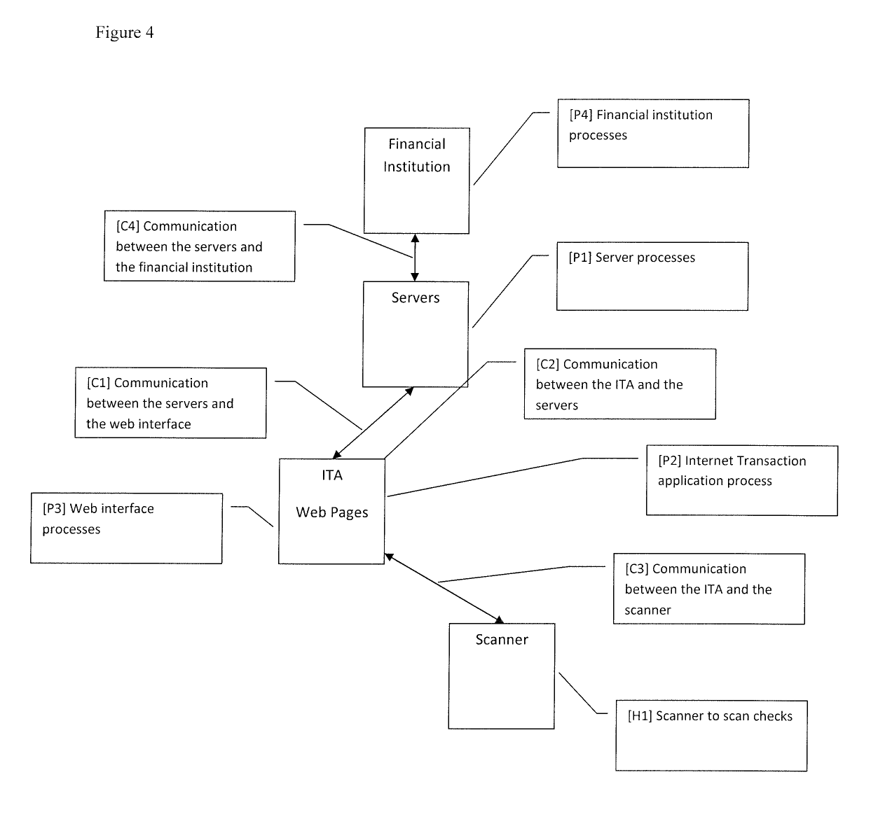

FIG. 4 discloses the interconnections between the servers, the ITA, as well as other hardware and software components used in combination with the ITA for the purpose of completely remote deposit transactions. FIG. 4 discloses the ability to initiate the ITA through code embedded in one or more web pages.

The server typically provides a connection between the ITA and the computer systems of the financial institutions to which the deposits are directed. The server typically would be remotely located from the financial institution and have the ability to service several such institutions. Or course, alternative placement of the server is also possible

[P1] This identifies one or more server processes that manage/record the deposits and submit the final deposit to the financial institution. In FIG. 4, the server processes also include the web server that will serve the web pages, and therefore the ITA. In addition to being able to initiating the ITA, the web servers also provide interfaces for username/password logins, historical data of deposits and research capability (searching of records).

[P2] This shows the ITA as described herein.

[P3] This shows the web interface that will initiate and in fact comprise the ITA and provides the interface to the server, and the server functionality.

[P4] This shows the financial institution servers/processes, which ultimately receives the remote deposit capture transaction and credits it to the appropriate account or accounts, and/or the core system or process that will submit the check data to a processing center or the Federal Reserve.

[C1] This shows the communication link between the servers and the web interface for the exchange of information described in reference to P1 and P3.

[C2] This shows the communication link between the ITA and the server for the exchange of information described in reference to P1 and P2, such as deposit information (image data, account numbers, check amounts, ID numbers), and error codes among other information.

[C3] This shows the communication link between the scanner/digital camera and the ITA for transfer of the images of checks, and MICR data (if the scanner can read MICR data).

[C4] This shows the communication link between the servers and the financial institution for the exchange of check information and images in a know format (e.g. X9.37 or other format).

[H1] This shows the scanner that can be any image scanner that is Twain compliant or a dedicated check scanner (alternately, no scanner can be used and images can be loaded locally). The communication is generally done through a USB cable. Alternatively, a digital camera that produces a digital photographic image can be used as well.

In this manner the system of the present invention substantially overcomes the limitations of the prior art.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A method for performing remote deposit capture, comprising:
providing a computer system comprising one or more processors wherein the steps of the method are carried out under the control of computer code operating thereon;
providing a scanner;
creating an electronic file from a digital capture of a paper instrument associated with a transaction; and
processing the information to complete the transaction.

2. The method of claim 1 wherein the transaction is related to a loan.

3. The method of claim 2 wherein the transaction is completing a loan application.

4. The method of claim 2 wherein the transaction is making a loan payment.

5. The method of claim 2 further comprising the step of collecting personal information.

6. The method of claim 5 wherein the personal information is obtained from the capture of the paper instrument.

7. The method of claim 2 further comprising the step of verifying income.

8. The method of claim 7 wherein the verification of income is completed by analyzing information from the captured paper instrument.

9. The method of claim 2 further comprising the step of verifying the paper instrument through human review of the captured paper instrument.

10. The method of claim 1 wherein the capture uses a digital camera.

11. The method of claim 1 wherein the capture uses a scanner.

12. The method of claim 1 wherein the computer system is a mobile based computer program application.

13. The method of claim 2 further comprising the step of allocating a payment stream between multiple sources.

14. The method of claim 13 wherein the allocation is verifying to determine if minimum payment requirements are met.

15. The method of claim 14 wherein the transaction is terminated is the requirements are not met.
